(19) United States
(12) Patent Application Publication
(10) Pub. No.: US 2021/0011137 A1
(43) Pub. Date: Jan. 14, 2021

(54) DEVICE FOR DETECTING A FOREST STAND

(71) Applicant: UMWELTDATA GMBH, Wolfsgraben (AT)

(72) Inventor: Günther Bronner, Tullnerbach (AT)

(21) Appl. No.: 17/040,910

(22) PCT Filed: Mar. 11, 2019
(86) PCT No.: PCT/AT2019/060081

§ 371 Date: Sep. 23, 2020

(30) Foreign Application Priority Data
Mar. 23, 2018 (AT) A 50245/2018

(51) Int. Cl. G01S 7/481; G01S 17/894; H04N 5/225

(52) U.S. Cl. CPC G01S 7/4817; H04N 5/2257; G01S 17/894

(57) ABSTRACT

Aspects of the present disclosure are directed to a device and to an associated method for detecting a forest stand. In one embodiment, a device for detecting a forest stand is disclosed including a base having a first laser scanner with a first viewing point provided for a measurement. The viewing point is the point at which the laser scanner is arranged for measurement. At least one second viewing point for measurement is provided, and that either the first laser scanner is movable between the first viewing point and the at least one second viewing point, or at least one second laser scanner is arranged in the at least one second viewing point for measurement, and the first laser scanner is arranged in the first viewing point.

The invention relates to a device for detecting a forest stand, wherein the device has a base with a first laser scanner and a first viewing point is provided for measurement, wherein the viewing point is the point at which the laser scanner is arranged for measurement.

In addition, the invention relates to a method for taking ambient scans in a forest stand with a device as indicated above, having a base on which in a first step a first laser scanner is arranged in a first viewing point on the base and the first laser scanner performs a first ambient scan from the first viewing point.

Laser scanners are used to capture the position and geometry of trees in the forest in high detail. In a frequently used application of laser scanners for this purpose, the laser scanner is mounted on a stand and the scanning unit rotates slowly around the vertical axis of the stand head during the scanning process. At the same time, the pulsed laser beam of the scanner scans the ambient environment in a circle around a horizontal axis, so that at the end of the scanning process a complete three-dimensional spherical image of the ambient environment is created, which only has a gap immediately below the stand.

Laser scanners are currently undergoing rapid development as they are used in the automotive industry for detecting the ambient environment during autonomous driving. They are continuously being miniaturized and produced at ever lower cost. A typical laser scanner used in the automotive industry has a horizontally rotating scanning unit in a cylindrical housing, which simultaneously emits vertically 8-16 laser pulses distributed over an aperture angle of 10°-20° and scans horizontally during rotation at high resolution over 360°.

The development is moving towards so-called solid-state laser scanners, which have no rotating parts and which emit laser pulses, for example, in a range of 120° by 10°. The angular resolution along the 120° is very high and along the 10° is only about 1°. These scanning units will be even smaller, lighter and cheaper than the cylindrical 360° scanners.

The three-dimensional image of the forest in the vicinity of a stand scanner is not complete in the above-mentioned traditional application, because trees closer to the scanner can completely or partially obscure other trees further away in relation to the scanner position, so that these trees cannot be reached by the laser pulses at all or only partially. This disadvantage is sometimes compensated by the fact that a piece of forest is captured from several scanner positions and the resulting individual point clouds are combined in a subsequent data processing operation.

The disadvantage is that firstly the device has to be set up several times, which results in a considerably longer scanning time, and secondly the data processing time is longer because of the necessary fusion of several data sets. In order to be able to orientate the individual point clouds to each other, several spherical register marks usually have to be distributed in the forest before the scanning process, which additionally increases the effort.

In order to record the geometric data of the forest stand, to record the diameters of individual trees and to assign them to their location, this was carried out up to now by the forester either manually, which is very time-consuming and cost-intensive. On the other hand, it is known to set up a recording device with a sensor, for example combined with a photogrammetric evaluation at special measuring points in the forest stand and thus to geometrically record as large a section of the forest stand as possible. It is problematic in this respect that the device remains fixed at one place during a measurement. It is not possible to check the recorded data during the measurement or on site.

For example, the recording device is mounted on the vehicle and is thus transported to several locations.

Due to the trees that are close to the recording device, the images obtained by this measurement are afflicted with blind spots and therefore large parts of the geometric data of the trees in the vicinity are missing to the recording device.

In order to nevertheless get an overview of the condition of wood stocks that are not easily accessible, several possibilities for inspection have been developed. A very expensive and complicated method is the measurement with an airplane or a helicopter from the air. Laser scanning is used to collect data from the position above the forest stand. In aircraft laser scanning, laser pulses are sent from several hundred meters above the ground almost perpendicularly to the earth's surface. Accordingly, there are echoes from tree tops, branches and the ground in the forest, but only a very small percentage is reflected by the trunks. Therefore, good measurements can be taken mainly in winter, because the canopy prevents a measurement from reaching the trunks of the trees during the rest of the year. Ultrasound or radar impulses are reflected by the canopy and the measurement result shows only the tree crowns.

It is the object of the present invention to increase the quality of the images at a reasonable cost.

This object is solved by an initially mentioned device according to the invention in that at least one second viewing point is provided for measurement, and in that either the first laser scanner is displaceable between the first viewing point and the second viewing point, or in that at least one second laser scanner is arranged in the second viewing point for measurement and the first laser scanner is arranged in the first viewing point. The advantage of providing two viewing points is that the device can at least partially look past trees in the foreground. Thus, a higher density of collected data can be achieved and the level of completeness of the measurement is increased. In addition, recording carried out by this device is easy and inexpensive.

The present invention differs substantially from the known triangulation, a geometrical method of optical distance measurement by means of precise angle measurement within triangles. The invention is not concerned with determining distance, but with shifting the viewing point in order to avoid optical obstacles—which are formed, for example, by trees in the foreground—and thereby generate additional measurement data about objects lying behind the obstacles.

Trials have shown that a significant effect is available in average Central European forest stands from a distance of more than 0.8 m from the viewing points. Therefore, it is advantageous if the second viewing point is spaced from the first viewing point by a length, wherein the length is of an amount greater than 0.8 m and preferably between 1 m and 2.5 m.

This object is also solved by an initially mentioned method in that a second ambient scan is carried out in a second step from a second viewing point, wherein the second viewing point has a length L to the first viewing point which is greater than 0.8 m and preferably between 1 m and 2.5 m.

A particularly simple device with particularly small external dimensions to ensure handiness is achieved when this length between the viewing points is achieved by a base rod on which the laser scanner is mounted and is at least partially bridged by this base rod.

Particularly accurate detection of the ambient environment can be achieved by a device that provides for the base rod to be rotated about a rotation axis relative to the base. This makes it easy to perform several ambient scans from different perspectives.

This is particularly advantageous if a drive is provided to rotate the base rod, which is located at the base or on the base rod, wherein the drive is preferably an electric motor.

It is convenient if the first laser scanner can be moved along the base rod of the base and can be arranged in the first viewing point and in the second viewing point. In this way, the viewing point can be easily changed along the base rod and the device remains inexpensive since only one laser scanner is needed.

In this process, the first laser scanner is moved between the first ambient scan and the second ambient scan from the first viewing point to the second viewing point—preferably by a linear drive.

An equivalent alternative is achieved when the first laser scanner is mounted eccentrically and pivotably on the base.

The first laser scanner is simply pivoted between the first ambient scan and the second ambient scan from the first viewing point to the second viewing point—preferably by an electric motor.

In order to be able to record a particularly large amount of geometric data of the ambient environment with high accuracy, it is advantageous if the laser scanner(s) performs/perform ambient scans during the movement. This can be achieved alternatively or additionally if the laser scanner is rotated around its own vertical axis in one of the viewing points to perform the ambient scan.

In order to be able to perform faster ambient scans, an alternative embodiment provides that a second laser scanner is arranged in the second viewing point and that the first laser scanner is arranged in the first viewing point. These two can then perform the first ambient scan and the second ambient scan simultaneously or consecutively.

To obtain a comprehensive picture of the ambient environment, it is advantageous if at least one laser scanner has an aperture angle that is greater than 100° and preferably greater or equal to 120°.

To make the alignment of the laser scanner or laser scanners as flexible as possible, it is advantageous if the base is a stand. This could be a typical stand or even an earth spike. In other embodiments, the base can form a device for mounting on a vehicle.

In order to be able to combine geometry data of the ambient scans with images of the ambient environment, or to be able to add information about tree species to the geometry data, it is advantageous if the device has at least one camera, wherein the camera is assigned to a viewing point, and if preferably two cameras are provided.

With a laser projector it is possible to project light spots onto the ambient environment during photo shoots and to enable an image matching process by means of the light spots in the shots. Thus, images can be automatically assigned to each other.

It is particularly advantageous to evaluate the geometry and position of the tree surfaces as well as the appearance of the tree surface in a stereo-photogrammetric manner from the images.

In order to further extend the possibility to record the ambient environment, a special embodiment of the device provides that the laser scanner(s) is/are rotatable—and preferably connected to a drive for rotation.

Laser scanners can be used to achieve particularly high-quality and good measurement results. These are used to determine the geometry and position of the tree surfaces in high resolution. These have at least one laser exit opening. If the laser scanner is rotatable, laser measuring pulses can be emitted in high resolution in all directions (360° in a horizontal plane).

A particularly advantageous arrangement results if the device has a hyperspectral sensor for visual and automatic detection of tree species, tree vitality or tree damage.

It is convenient if the device stores the recorded data in a data memory or if the device retransmits the recorded data. It is also useful if the device records the exact coordinates of the current position with the recording of the ambient scans. This way the ambient scans can be assigned to a point.

In order to avoid the above mentioned disadvantages, the scanning unit is positioned in the present invention on a horizontal cantilevered arm which is connected to a motor unit on the stand axis, wherein an electronically controlled gear motor slowly rotates the scanning unit on the cantilevered arm about the vertical stand axis. If, during this slow movement of the eccentric arm, a circular scanning of the ambient environment is performed around the horizontal axis of the arm, then the scanning is performed in the same direction from two scanning positions opposite each other with respect to the stand axis, with a time offset of twice the length of the eccentric arm. With a length of the eccentric arm of preferably at least 50 cm, this geometrical arrangement can avoid a large part of the shadows of standing trees at a distance from the stand without the need for an additional installation of the scanning unit.

A further advantage is that a single tree is not scanned from a single point as before, which means that—depending on the distance of the tree from the scanner and the diameter of the tree—less than half of the circumference is always captured, but from two positions whose distance from each other is greater than the tree diameter, so that more than half of the circumference can always be captured. The result of this improvement is that the reconstruction of the individual tree diameters when the stand is placed on only one point can be done with a higher accuracy than with traditional stand laser scanning.

Due to the progressive miniaturization of laser scanners, several solid-state scanners can be used instead of one scanner with circular scanning, which emit the pulses e.g. in an aperture angle of 120°. The staggered and/or overlapping arrangement of several such scanners or scan compartments can be optimized in particular in that the co-referencing of the point cloud fragments to be assigned to a single laser scanner is facilitated by the compression of the point cloud at the overlapping areas, thus increasing the accuracy.

A further possibility of the eccentric scanner arrangement is to arrange two laser scanners (or scanner combinations) at the ends of a horizontal arm, which cantilevers on both sides and rotates around the vertical axis of the stand. This symmetrical arrangement leads to a higher stability of the stand and additionally has the positive effect that in each case scanning is carried out simultaneously (and not in a time-shifted manner by the slow rotation of the arm) in the same direction. Moving targets, such as branches moved by the wind, are thus imaged more precisely and thus facilitate the co-referencing of the point cloud fragments.

In another arrangement of the scanning device according to the invention, the previously vertical axis, around which the cantilevered arm moves, is tilted so that the axis is aligned at right angles to the plane of the terrain and thus, in inclined terrain, the circular movement of the scanner is approximately parallel to the plane of the terrain.

All described arrangements of laser scanners can be supplemented by one or more cameras, which additionally capture the scanned ambient environment on photos or videos. They can be used for visual control of the scans as well as for automatic or visual addressing of tree species or trunk qualities.

A useful addition to the sensor arrangements described above is a digital unit for measuring the angle of rotation traveled, which allows the position of the laser scanner in space to be derived and thus improves the co-referencing of the point cloud fragments.

In a particularly favorable embodiment, the device has a recording module with a satellite-based radio module—preferably a 5^{th} generation mobile radio module—from which the data collected during the ambient scans are collected. Through the recording module, the authenticity of the recorded data as well as its temporal and local allocation is proven with blockchain technology, since the recorded data are linked in each case with place and time. The entire recording is thus defined in terms of time and place and is sealed in a tamper-proof manner.

In the following, the invention is explained in more detail on the basis of the non-restrictive figures, wherein:

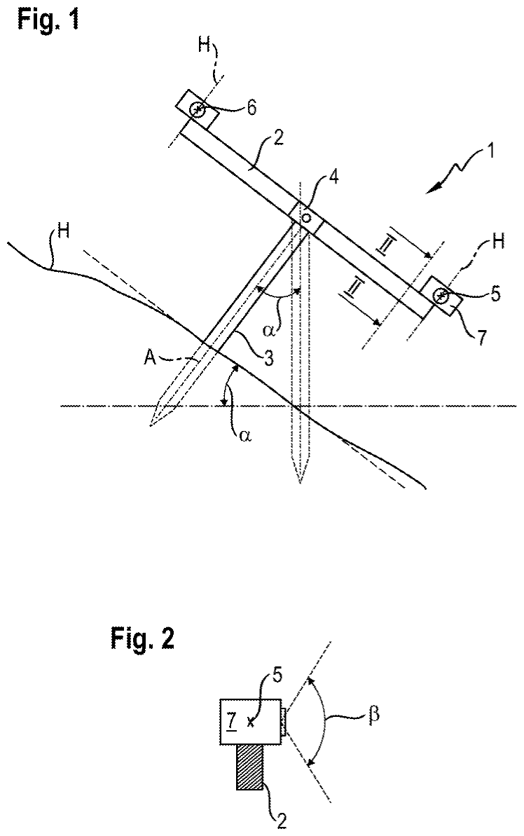

FIG. 1 shows a first embodiment of a device according to the invention in a side view;

FIG. 2 the first embodiment in a section according to line II-II in FIG. 1;

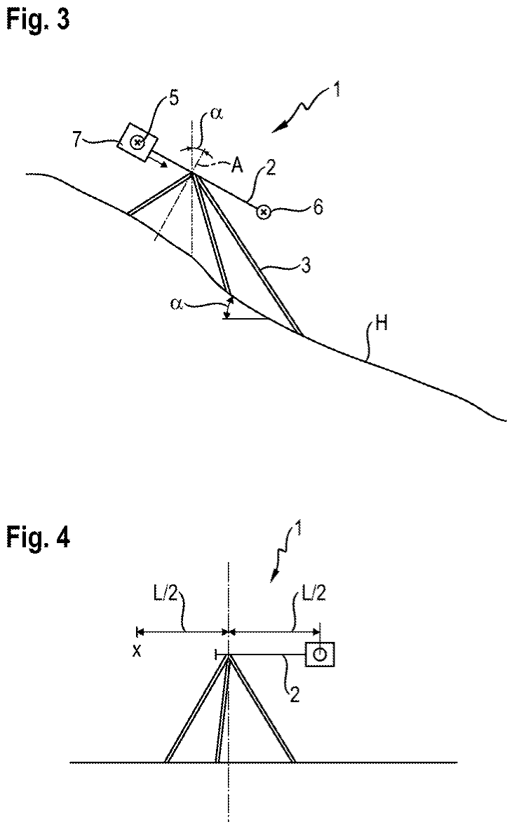

FIG. 3 a second embodiment of a device according to the invention in a side view; and

FIG. 4 a third embodiment of a device according to the invention.

FIG. 1 shows a device 1 in a first embodiment. The device 1 has a base rod 2, which is mounted on a stand 3 so that it can be rotated about a rotation axis A. The base rod 2 has a drive 4 to the stand 3. On the base rod 2 a first laser scanner 7 and a second laser scanner 8 are arranged in a first viewing point 5 and in a second viewing point 6 respectively. These two laser scanners 7 and 8 can each be rotated around their vertical axis H. In the embodiment shown, a drive is provided to rotate the laser scanners 7 and 8 relative to the base rod 2. The two viewing points 5 and 6 have a length L between them, which is about 1.5 m.

The device 1 shown in FIG. 1 is located on a slope H with an approximate inclination by an angle α. The stand 3 in this embodiment is an earth spike, which is driven into the earth either vertically (shown in dashed lines), or normally to the slope H. If the stand 3 is vertically aligned, the base rod 2 can be swivelled in relation to the stand and can be fixed, for example, with a screw essentially parallel to the slope H. This makes it easier to capture the surroundings, since otherwise, on a steep slope, part of the image would only show the slope H.

FIG. 2 shows a laser scanner with an aperture angle β, which is 120° in the embodiment shown.

FIG. 3 shows a second embodiment of the device 1, where only the first laser scanner 7 is provided, which is located in the first viewing point 5 at the considered moment. The first laser scanner 7 can be moved along the base rod 2 either manually or via a drive until the second viewing point 6. The stand 3 is designed as a tripod in this embodiment.

A third embodiment of device 1 is shown in FIG. 4. In contrast to the other embodiments, the base rod 2 is arranged eccentrically with a length L/2 around the rotation axis A and, as in the second embodiment, only a first laser scanner 7 is arranged first in a viewing point 5. The base rod 2 is pivoted in a second step, so that the first laser scanner 7 is then arranged in the second viewing point 6.

1. A device for detecting a forest stand comprising:
a base with a first laser scanner having
a first viewing point, the first viewing point configured and arranged for providing a measurement, wherein the viewing point is the point at which the laser scanner is arranged for measurement, and
wherein at least one second viewing point is provided for measurement;
wherein either the first laser scanner is displaceable between the first viewing point and the second viewing point, or in that at least one second laser scanner is arranged in the second viewing point for measurement and the first laser scanner is arranged in the first viewing point;
wherein the second viewing point is spaced from the first viewing point by a length (L) that is greater than 0.8 m; and
a base rod is arranged at the base, on which the first laser scanner is arranged, and the base rod is arranged to be rotatable about a rotation axis (A) relative to the base.

2-4. (canceled)

5. The device according to claim 1, further including a drive configured and arranged for rotating the base rod, the drive is arranged on the base or on the base rod.

6. The device according to claim 1, wherein the first laser scanner is configured and arranged to be displaceable along the base rod of the base and thereby can be arranged in the first viewing point and in the second viewing point.

7. The device according to claim 1, characterized in that the first laser scanner is eccentrically and pivotally mounted on the base.

8. The device according to claim 1, characterized in that the first laser scanner has an aperture angle (β) which is greater than 100°.

9. The device according to claim 1, characterized in that the base is a stand.

10. The device according to claim 1, further including at least one camera, wherein the camera is assigned to at least one of the first and second viewing points.

11. The device according to claim 1, characterized in that at least one of the laser scanners are rotatable.

12. The device according to claim 1, further including a recording module with a satellite-based radio module.

13. Method for recording ambient scans in a forest stand with a device according to claim 1 having a base on which, in a first step, the first laser scanner is arranged in the first viewing point on the base and the first laser scanner performs a first ambient scan from the first viewing point, characterized in that, in a second step, a second ambient scan is performed from the second viewing point.

14. The method according to claim 13, characterized in that the first laser scanner is displaced between the first ambient scan and the second ambient scan from the first viewing point to the second viewing point.

15. The method according to claim 13, characterized in that the first laser scanner is pivoted between the first ambient scan and the second ambient scan from the first viewing point to the second viewing point.

16. The method according to claim 13, characterized in that the first laser scanner and the at least one second laser scanner, which are arranged in the second viewing point, perform the first ambient scan and the second ambient scan.

17. The method according to claim 14, characterized in that the first laser scanner performs ambient scans during the displacement.

18. The method according to claim 13, in that the laser scanner is rotated around its own vertical axis (H) in one of the viewing points to perform the ambient scan.

19. The method according to claim 13, characterized in that a recording module with a satellite-based radio module provides recorded data with a temporal and local assignment by blockchain technology.

20. The device of claim 1, wherein the second viewing point is spaced from the first viewing point by a length (L), wherein the length (L) is between 1 meter and 2.5 meters.
